(19) United States
(12) Patent Application Publication
(10) Pub. No.: US 2009/0027561 A1
(43) Pub. Date: Jan. 29, 2009

(54) MOBILE TV SYSTEM WITH USB INTERFACE

(75) Inventors: Christopher Cytera, Cambridge (GB); Stephen A. Mueller, Foothill Ranch, CA (US); Xuguang (Gary) Zhang, Aliso Viejo, CA (US)

Correspondence Address: FIALA & WEAVER, P.L.L.C.;C/O INTELLEVATE, P.O. BOX 52050, MINNEAPOLLS, MN, 55402, US

(73) Assignee: BROADCOM CORPORATION, Irvine, CA (US)

(21) Appl. No.: 11/782,166

(22) Filed: Jul. 24, 2007

(51) Int. Cl. H04N 5/46

(52) U.S. Cl. 348/729; 348/E05.113; 348/E05.097

(57) ABSTRACT

Methods, systems, and apparatuses for enabling mobile TV functionality and universal serial bus (USB) functionality are provided. In an example aspect, a mobile television (TV) system includes a mobile TV receiver module and a universal serial bus (USB) interface. The mobile TV receiver module receives a radio frequency (RF) mobile TV signal that includes TV data, and generates a mobile TV data signal that includes the TV data. The USB interface receives the mobile TV data signal, and generates a USB output data signal that includes the TV data. In an aspect, the mobile TV functionality and USB functionality are provided in an integrated circuit chip. In one example, the mobile TV functionality and USB functionality share at least one power supply. In another example, the mobile TV functionality and USB functionality are powered by respective power supplies that are electrically isolated from each other. In such a chip configuration, the chip may be incorporated in a first device that utilizes the USB functionality of the chip, or in a second device that withholds power from the USB functionality.

### BACKGROUND OF THE INVENTION

1. Field of the Invention

The present invention relates to mobile television (TV) systems.

2. Background Art

Mobile TV systems are being developed to enable TV services to be provided by mobile devices, such as cell phones, over mobile telecommunications networks. Mobile TV systems enable users to view TV content on their mobile devices. Video, audio, and interactive content may be provided by mobile TV broadcasts. Many broadcasters already provide mobile TV broadcasts, and the number of such broadcasts is steadily increasing. Mobile TV signals from broadcasters can be broadcast according to numerous mobile TV standards.

What is desired are improved integrated circuits for enabling mobile TV functionality in mobile devices. Furthermore, what is desired are integrated circuits providing mobile TV functionality in a power efficient manner, particularly because mobile devices are frequently powered by batteries.

### BRIEF SUMMARY OF THE INVENTION

Methods, systems, and apparatuses for enabling mobile television (TV) functionality using industry standard connector interface functionality are provided. According to example embodiments of the present invention, mobile TV functionality is enabled to be interfaced with devices using an industry standard connector interface, such as a universal serial bus (USB) interface. The USB-enabled mobile TV functionality may be implemented in a wide range of device types, including computers and mobile devices such as cell phones, laptops, handheld computers, music players, etc. The USB-enabled mobile TV functionality may be implemented in a wide range of form factors, including dongles and sticks, and including circuit boards, such as mother boards and standard card forms that are insertable in standard card slots.

In an example aspect of the present invention, a mobile TV system includes a mobile TV receiver module and a USB interface. The mobile TV receiver module receives a radio frequency (RF) mobile TV signal that includes TV data, and generates a mobile TV data signal that includes the TV data. For example, the mobile TV receiver module may down-convert and demodulate the RF mobile TV signal to generate the mobile TV data signal. The USB interface receives the mobile TV data signal, and generates a USB output data signal that includes the TV data.

Any mobile TV standard may be enabled in devices according to embodiments of the present invention, including DVB-H (digital video broadcasting-handheld), DVB-SH (digital video broadcasting-satellite handheld), DMB (digital multimedia broadcasting), TDtv, 1seg, DAB, or MediaFLO.

In an example, the mobile TV functionality and USB interface are provided together in an integrated circuit chip. In one aspect, the mobile TV functionality and USB interface share at least one power supply voltage on the chip. In another aspect, the mobile TV functionality and USB interface are provided in separate power domains of the chip. In this manner, if the USB functionality is not needed in a host device, the mobile TV functionality may be powered, while separately withholding power from the USB functionality.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a USB-enabled mobile TV system, according to an example embodiment of the present invention.

FIG. 2 shows a flowchart providing example steps for providing mobile TV content to a mobile device, according to an example embodiment of the present invention.

FIG. 3 shows a block diagram of a mobile TV receiver module, according to an example embodiment of the present invention.

FIG. 4 shows a block diagram of a USB interface, according to an example embodiment of the present invention.

FIG. 5 shows a block diagram of an integrated circuit chip that includes the USB-enabled mobile TV system of FIG. 1, according to an example embodiment of the present invention.

FIG. 6 shows a flowchart providing example steps for powering the chip of FIG. 5, according to an example embodiment of the present invention.

FIGS. 7 and 8 show devices that includes the chip of FIG. 5, according to example embodiments of the present invention.

FIG. 9 shows an integrated circuit chip that includes the USB-enabled mobile TV system of FIG. 1 with isolated power domains, according to an example embodiment of the present invention.

FIG. 10 shows a flowchart providing example steps for powering the chip of FIG. 9, according to an example embodiment of the present invention.

FIG. 11 shows a flowchart providing example steps for assembling a device incorporating a chip, such as the chip of FIG. 9, according to an example embodiment of the present invention.

FIG. 12 shows a block diagram of an integrated circuit chip that includes the USB-enabled mobile TV system of FIG. 1 and additional functionality, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Example Mobile TV Systems

Embodiments of the present invention relate to mobile TV systems. Mobile TV systems provide TV services to mobile devices, such as cell phones, handheld mobile computers (e.g., personal digital assistants (PDAs), BLACKBERRY devices, PALM devices, etc.), music players (e.g., MP3 players, IPOD devices, etc.), over mobile telecommunications networks. Mobile TV enables users to access TV related content on their mobile devices. Video, audio, and interactive content may be provided by mobile TV broadcasts. Many broadcasters already provide mobile TV broadcasts, and the numbers of such broadcasts in the marketplace are steadily increasing.

Mobile TV signals from broadcasters are being broadcast according to numerous mobile TV standards. Example mobile TV standards include digital video broadcasting-handheld (DVB-H), digital multimedia broadcasting (DMB), TDtv, 1seg, DAB, and MediaFLO.

Integrating mobile TV into mobile devices provides design challenges due to their small size. Integrated circuits that provide mobile TV functionality to mobile devices typically are designed specific to a device type. Furthermore, mobile TV circuits consume a large amount of power, which is undesirable in mobile devices powered by batteries. Thus, improved integrated circuits are desired that enable mobile TV in a wider range of mobile device types, and that are power efficient.

Embodiments of the present invention overcome deficiencies of conventional mobile TV circuits. Example embodiments of the present invention are described in detail in the following section.

### EXAMPLE EMBODIMENTS

Embodiments of the present invention combine mobile TV functionality with functionality of an industry standard connector interface, such as a USB connector. Incorporation of industry standard connector functionality enables the mobile TV functionality to be interfaced with a greater number of devices due to the flexibility and wide-spread use of industry standard connectors. For example, an integrated circuit chip of the present invention may include both mobile TV functionality and a USB (universal serial bus) interface. Such integrated circuit chips may be implemented in a wide range of device types, including USB dongles and USB sticks that can be coupled to devices to provide mobile TV functionality, as well as on circuit boards such as MiniCards and mother boards that may reside inside or may be inserted into devices.

In an embodiment, the mobile TV functionality and industry standard connector interface functionality are provided in separate power domains of an integrated circuit chip. Thus, if the interface functionality is not needed, power can be provided to the mobile TV functionality, while being withheld from the interface functionality, saving mobile device power.

The example embodiments described herein are provided for illustrative purposes, and are not limiting. The examples described herein may be adapted to any type of mobile TV standard. Furthermore, additional structural and operational embodiments, including modifications/alterations, will become apparent to persons skilled in the relevant art(s) from the teachings herein.

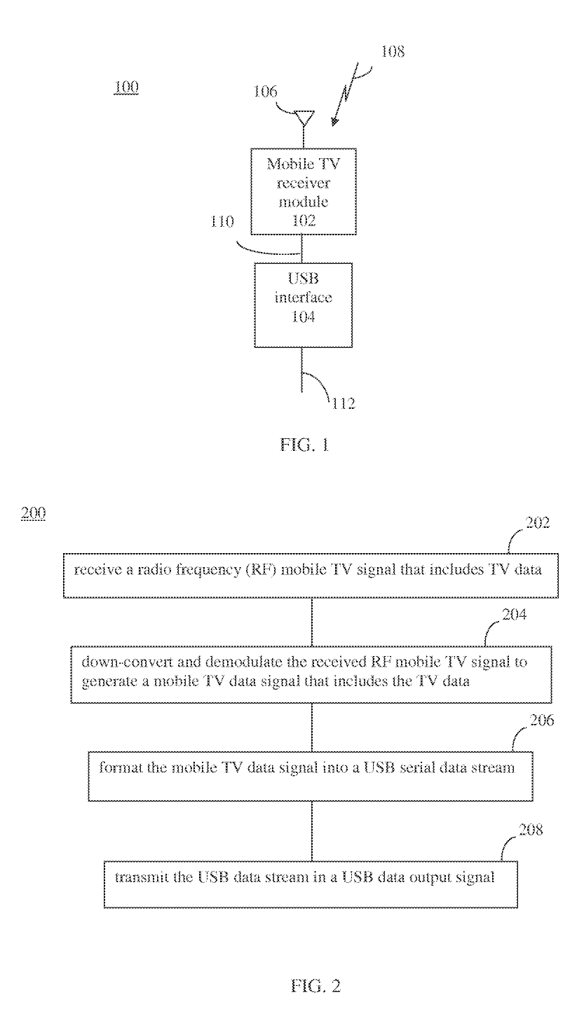

FIG. 1 shows a USB-enabled mobile TV system 100, according to an example embodiment of the present invention. As shown in FIG. 1, system 100 includes a mobile TV receiver module 102, a USB interface 104, and an antenna 106. System 100 can be implemented in a variety of ways, including in hardware, software, firmware, or any combination thereof. For example, system 100 may be implemented in one or more integrated circuit chips, a combination of one or more integrated circuit chips and a circuit board, etc. System 100 may include digital logic and/or one or more processors executing code to perform one or more of its functions. Furthermore, although interface 104 is described herein as a USB interface, embodiments are applicable to other industry standard interface connector technologies currently in use or to be developed, as would be understood by persons skilled in the relevant art(s) from the teachings herein.

Antenna 106 receives a radio frequency (RF) mobile TV signal 108. RF mobile TV signal 108 includes TV data. For example, RF mobile TV signal 108 is one of a digital video broadcasting-handheld (DVB-H) signal, a DVB-SH (satellite services to handheld devices) signal, a digital multimedia broadcasting (DMB) signal (e.g., T-DMB or S-DMB), a TDtv signal, a 1seg signal, a DAB signal, a MediaFLO signal, or other type of mobile TV signal. Antenna 106 may be any type of antenna, including a circuit board mounted antenna, an antenna integrated into an integrated circuit, a housing mounted antenna, etc. For example, antenna 106 may be a dipole antenna, a dual dipole antenna, a patch antenna, or other antenna type.

Mobile TV receiver module 102 receives RF mobile TV signal 108 from antenna 106. Mobile TV receiver module 102 is configured to generate a mobile TV data signal 110 that includes the TV data. Depending on the particular embodiment for mobile TV receiver module 102, mobile TV data signal 110 may be formatted according to any of the mobile TV standards mentioned elsewhere herein, or otherwise known. For example, in a DVB-H embodiment for mobile TV receiver module 102, mobile TV data signal 110 may be a stream of IP (Internet protocol) packets containing the TV data. For further description of DVH-B, refer to “Digital Video Broadcasting (DVB); Transmission System for Handheld Terminals (DVB-H),” ETSI EN 302 304 V11.1 (2004-11), European Broadcasting Union, European Telecommunications Standards Institute, Copyright 2004, which is incorporated herein by reference in its entirety.

USB interface 104 receives mobile TV data signal 110 from mobile TV receiver module 102. USB interface 104 is configured to generate a USB data signal 112 that includes the TV data. USB data signal 112 includes serial data formatted in a packet stream according to a USB standard, such as the USB standard revision 2.0, a prior USB standard (e.g., revisions 1.0 or 1.1), or future developed USB standard. For further description of USB standard revision 2.0, refer to “Universal Serial Bus Specification, Revision 2.0,” Apr. 27, 2000, Copyright 2000 (hereinafter USB 2.0 Specification), which is incorporated herein by reference in its entirety.

In one embodiment, USB interface 104 is configured to operate in a USB 2.0 High Speed Mode, as described in the aforementioned USB 2.0 Specification. In particular, the USB 2.0 Specification defines a third transfer rate of 480 Mb/s to the 12 Mb/s and 1.5 Mb/s rates of the prior USB specifications. According to the USB 2.0 High Speed Mode, embodiments of the present invention are enabled to provide mobile TV video data received by mobile TV receiver module 102 over USB interface 104 at very high rates. Refer to the USB 2.0 Specification for further details on configuring USB interface 104 to operate according to the USB 2.0 High Speed Mode.

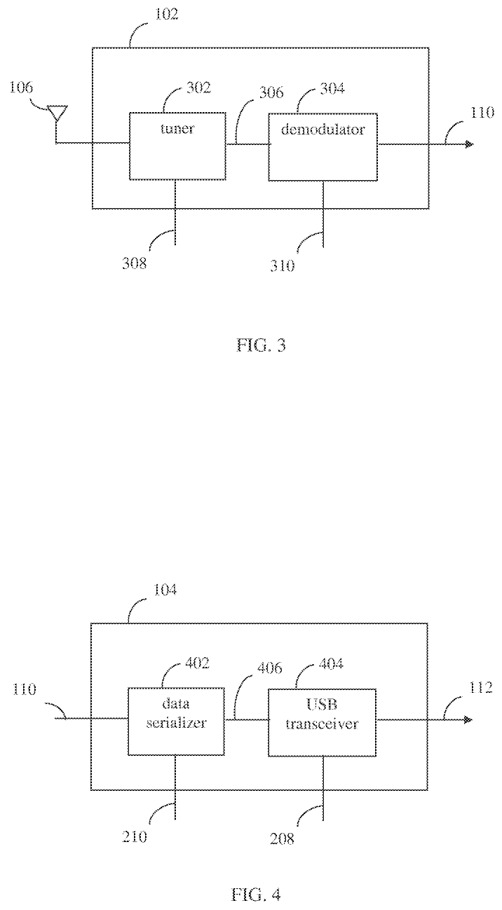

FIG. 2 shows a flowchart 200 providing example steps for providing mobile TV content to a mobile device, according to an example embodiment of the present invention. For example, system 100 shown in FIG. 1 may operate according to flowchart 200, in an embodiment. Other structural and operational embodiments will be apparent to persons skilled in the relevant art(s) based on the discussion regarding flowchart 200. Flowchart 200 is described as follows.

Flowchart 200 begins with step 202. In step 202, a radio frequency (RF) mobile TV signal is received that includes TV data. For example, as shown in FIG. 1, antenna 106 receives RF mobile TV signal 108.

In step 204, the received RF mobile TV signal is down-converted and demodulated to generate a mobile TV data signal that includes the TV data. For example, mobile TV receiver module 102 down-converts and demodulates RF mobile TV signal 108. FIG. 3 shows a block diagram of mobile TV receiver module 102, according to an example embodiment of the present invention. As shown in FIG. 3, mobile TV receiver module 102 includes a tuner 302 and a demodulator 304. Tuner 302 is coupled to antenna 106. In an embodiment, tuner 302 down-converts RF mobile TV signal 108 to a down-converted mobile TV signal 306. For instance, RF mobile TV signal 108 may have a carrier frequency in the VHF (very high frequency), UHF (ultra high frequency), or L band, that tuner 302 down-converts to an intermediate and/or baseband frequency. Tuner 302 may include a receiver or transceiver configured in any manner (e.g., heterodyne, superheterodyne, direct-conversion, etc.) to perform the frequency down-conversion function.

As shown in FIG. 3, demodulator 304 receives down-converted mobile TV signal 306. In an embodiment, demodulator 304 performs the demodulation portion of step 204. Demodulator 304 demodulates down-converted mobile TV signal 306 to generate mobile TV data signal 110. Demodulator 304 may be configured in any way, depending on a particular mobile TV implementation. For example, in an embodiment, demodulator 304 may be configured to demodulate signals formatted according to OFDM (orthogonal frequency division multiplexing), which uses a large number of closely-spaced orthogonal sub-carriers, each sub-carrier being modulated with a conventional modulation scheme (such as quadrature amplitude modulation (QAM) or quadrature phase shift keying (QPSK)). OFDM is utilized in various mobile TV formats, including ISDB-T, T-DMB, DVB-H, and MediaFLO. Configurations for demodulating an OFDM signal are known to persons skilled in the relevant art(s), and are applicable to demodulator 304.

In embodiments, mobile TV receiver module 102 may perform further functions to receive and extract TV data from an RF mobile TV signal, including time slicing, IP data extraction, IP data error correction (e.g., multiprotocol encapsulation forward error correction (MPE-FEC)), etc., depending on the particular mobile TV format implementation.

In step 206, the mobile TV data signal is formatted into a USB serial data stream. For example, as shown in FIG. 1, USB interface 104 formats mobile TV data signal 110 into USB data signal 112, which includes the TV data formatted into a packet stream according to a USB standard. FIG. 4 shows a block diagram of USB interface 104, according to an example embodiment of the present invention. As shown in FIG. 4, USB interface 104 includes a data serializer 402 and a USB transceiver 404. Data serializer 402 receives mobile TV data signal 110. In an embodiment, data serializer 402 formats the TV data received in mobile TV data signal 110 into a serial USB data packet stream 406. Refer to the above mentioned “Universal Serial Bus Specification, Revision 2.0,” at Chapter 5, “USB Data Flow Model,” for further description of example data formatting/protocol performed by data serializer 402. Data serializer 402 may be implemented in hardware, such as digital logic, software, firmware, or any combination thereof to perform its functions.

In step 208, the USB data stream is transmitted in a USB data output signal. In an embodiment, USB transceiver 404 of USB interface 104 receives serial USB data packet stream 406 and transmits USB data signal 112. USB transceiver 404 may include one or more data drivers, including differential data drivers, to transmit USB data signal 112. USB transceiver 404 may also include data receivers, including differential data receivers, to receive data from a host on USB data signal 112. Thus, in an embodiment, USB data signal 112 is transmitted on a bi-directional signal line. Refer to the above mentioned “Universal Serial Bus Specification, Revision 2.0,” at Chapter 7, “Electrical,” for further description of an example implementation of USB transceiver 404.

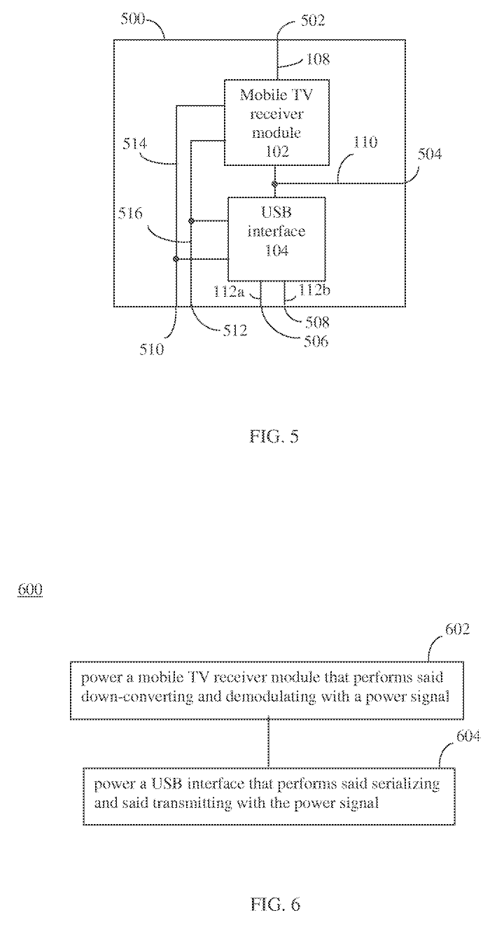

As described above, system 100 can be implemented in one or more integrated circuit chips. For example, FIG. 5 shows an integrated circuit chip 500 that includes system 100. As shown in FIG. 5, chip 500 includes mobile TV receiver module 102 and USB interface 104. Chip 500 may be a chip singulated from a semiconductor wafer, such as a silicon (Si) or gallium arsenide (GaAs) wafer. Although shown in FIG. 5 without antenna 106, in an embodiment, antenna 106 may be included in chip 500.

As shown in FIG. 5, chip 500 includes pads 502, 504, 506, 508, 510, and 512, and first and second power signals 514 and 516. Pads 502, 504, 506, 508, 510, and 512 are pads of chip 500 that enable access to their respective signals external to chip 500. Pads 502, 504, 506, 508, 510, and 512 may be coupled to a pin, lead, or solder ball of an integrated circuit package that includes chip 500. Pad 502 is coupled to RF mobile TV signal 108. Pad 504 is coupled to mobile TV data signal 110. In the embodiment of FIG. 5, USB data signal 112 is a differential signal, having a “+” portion and a “−” portion. Pad 506 is coupled to the “+” signal portion 112a of a differential USB data signal 112, and pad 508 is coupled to the “−” signal portion 112b of the differential USB data signal 112. Pad 510 is coupled to a first power signal 514. Pad 512 is coupled to a second power signal 516.

First and second power signals 514 and 516 are received by both of mobile TV receiver module 102 and USB interface 104. In embodiments, chip 500 may have one or more power supplies to power circuits of chip 500, as needed for a particular implementation. In the example of FIG. 5, first and second power signals 514 and 516 are present. In an embodiment, first power signal 514 may be a digital power supply voltage and second power signal 516 may be an analog power supply voltage. For example, first power signal 514 may be a 1.2 Volt, 5 Volt, or any other suitable digital power supply voltage.

In the embodiment of FIG. 5, first power signal 514 and second power signal 516 are received by both of mobile TV receiver module 102 and USB interface 104. In an alternative embodiment, first power signal 514 may be received by both of mobile TV receiver module 102 and USB interface 104, while second power signal 516 is only received by USB interface 104. In an embodiment, multiple analog power signals are received by USB interface 104. For example, USB interface 104 may receive a 3.3 Volt supply used to power an I/O circuit portion (e.g., an output portion of USB transceiver 404 shown in FIG. 4) and a 2.5 Volt supply used to power analog circuitry (e.g., amplifiers of USB transceiver 404). Any voltage values and numbers of power supply voltages are within the scope and spirit of embodiments of the present invention.

Note that ground signals are not shown in FIG. 5, for ease of illustration. One or more ground signals corresponding to power signals of chip 500 may be present, in embodiments.

FIG. 6 shows a flowchart 600 providing example steps for powering chip 500, according to an example embodiment of the present invention. Other structural and operational embodiments will be apparent to persons skilled in the relevant art(s) based on the discussion regarding flowchart 600. Flowchart 600 is described as follows.

Flowchart 600 begins with step 602. In step 602, a mobile TV receiver module that performs said down-converting and demodulating is powered with a power signal. For example, as shown in FIG. 5, mobile TV receiver module 102 is powered by first power signal 514 (and by second power signal 516).

In step 604, a USB interface that performs said serializing and said transmitting is powered with the power signal. For example, as shown in FIG. 5, USB interface 104 is powered by first power signal 514 (and by second power signal 516).

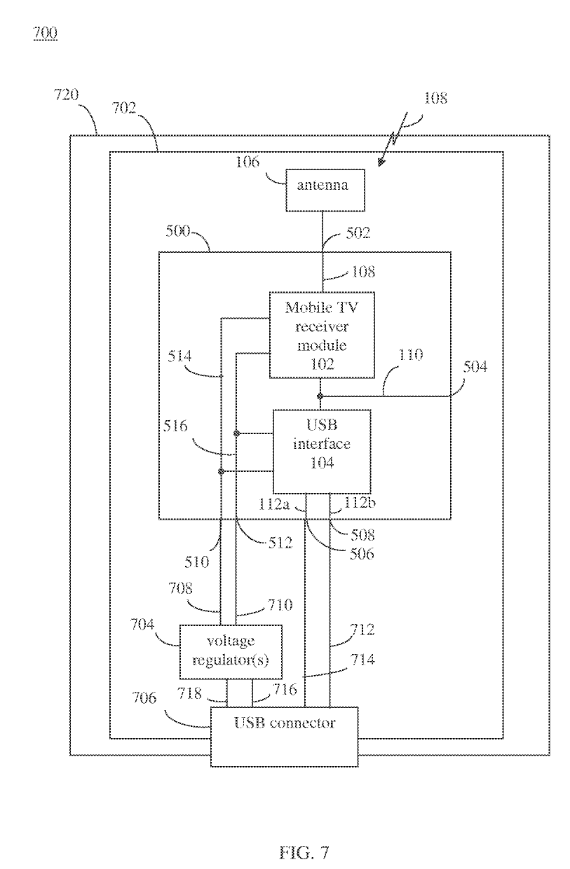

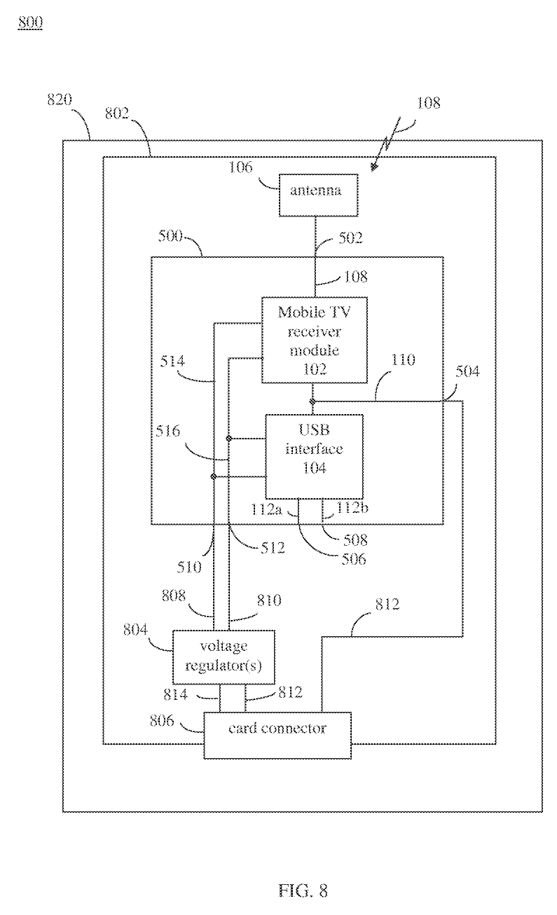

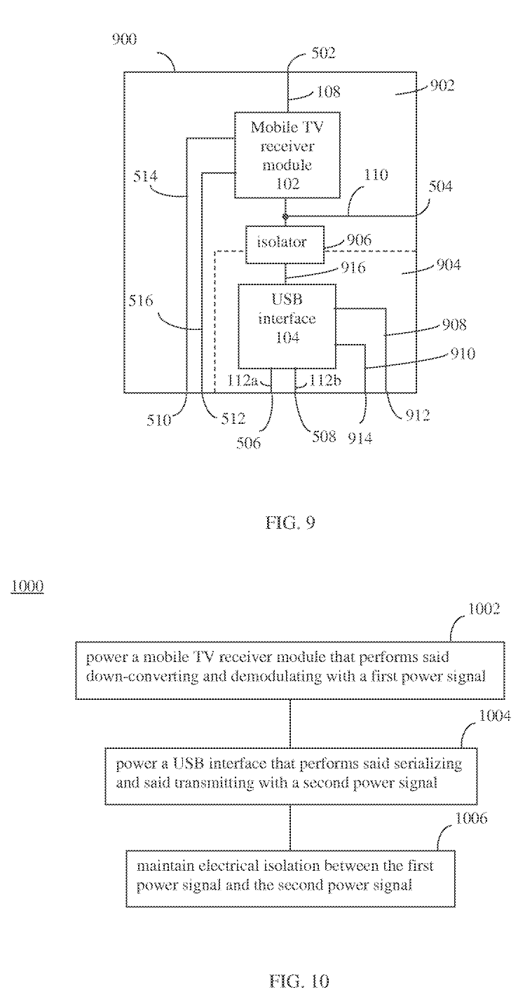

Chip 500 may be incorporated in a variety of device types in a variety of ways. For instance, FIGS. 7 and 8 show some example mobile devices in which chip 500 can be implemented, according to embodiments of the present invention. FIG. 7 shows a device 700 that includes chip 500 that may be a dongle or “stick”-type device, for example, to be interfaced with a user device using an industry standard USB connector to provide mobile TV functionality to the user device. FIG. 8 shows a device 800, where chip 500 is mounted to an internal circuit board of device 800.

As shown in FIG. 7, device 700 includes a circuit board 702, antenna 106, chip 500, a voltage regulator 704, a USB connector 706, and a housing 720. As shown in the example of FIG. 7, antenna 106, chip 500, and voltage regulator 704 are mounted to circuit board 702. Housing 720 houses circuit board 702, antenna 106, chip 500, and voltage regulator 704. As mentioned above, device 700 is a device that includes an industry standard connector for interfacing with a mobile device. For instance, device 700 may have a “stick” form, similar to a memory stick. In such an embodiment, housing 720 may have dimensions of approximately 50.0 mm (W)×21.5 mm (H)×2.8 mm (D), or may be of smaller or larger size. Housing 720 may be made from plastic, metal, or other material. USB connector 706 extends from housing 720, to allow device 700 to be plugged into another standard USB connector that mates with USB connector 706. USB connector 706 may allow device 700 to be interfaced with any user device that includes a mating USB connector, such as a computer system, a TV monitor, a cell phone, a mobile computer, etc.

Circuit board 702 may be any type of circuit board, including a printed circuit board (PCB). In embodiments, chip 500 may be mounted to circuit board 702 in any suitable way, including by an integrated circuit package, such as a dual in-line (DIP) package, leadless chip carrier (LCC), pin grid array (PGA) package, quad flat package (QFP), or ball grid array (BGA) package, including a fine pitch BGA package or wafer-level BGA package. As shown in FIG. 7, antenna 106 is coupled to pad 502 by electrical routing of circuit board 702.

USB connector 706 may be a USB series “A” or “B” plug, for example. USB connector 706 provides a power supply voltage signal 716 (also referred to as VBUS) and a ground signal 718 to circuit board 702. Thus, power and ground can be received at USB connector 706 from an external power source. Pads 506 and 508 of chip 500 are respectively coupled to a D+ and D− pins of USB connector 706 by first and second electrical connections 712 and 714, respectively providing the “+” and “−” signal portions 112a and 112b of the differential USB data signal 112 to USB connector 706.

Note that alternative types of USB connection mechanisms may be used, other than a USB connector such as USB connector 706. For example, circuit board 702 may have pins, contacts, “contact plates,” or other type of connection mechanism along an edge for coupling signals of the circuit board to a mating connector of the device into which the circuit board is inserted. Thus, in an alternate embodiment, instead of including USB connector 706 with circuit board 702, pads 506 and 508 of chip 500 may be coupled to respective pins, contact, “contact plates,” or other connection mechanism of circuit board 702 (e.g., in parallel with other I/O signals), such as an edge connector.

Power supply voltage signal 716 and ground signal 718 are received from USB connector 706 at voltage regulator 704. Voltage regulator 704 includes one or more voltage regulators to convert a power supply voltage received on power supply voltage signal 716 to one or more additional power supply voltages for use by chip 500 and/or other components mounted to circuit board 702. For example, as shown in FIG. 7, voltage regulator 704 generates first power supply 514 and second power supply 516 of chip 500. A first electrical connection 708 routed on circuit board 702 is coupled to pad 510 of chip 500 to supply the voltage of first power supply 514. A second electrical connection 710 routed on circuit board 702 is coupled to pad 512 of chip 500 to supply the voltage of second power supply 516. Note that in an alternative embodiment, voltage regulator 704 may be located in chip 500, and power supply voltage signal 716 and ground signal 718 may be routed to chip 500 to be supplied to voltage regulator 704 in chip 500. In still another embodiment, a combination of one or more voltage regulators 704 located on circuit board 702 and in chip 500 may be used to generate desired power supply voltages from power supply voltage signal 716 and ground signal 718. Power supply voltages may be provided in alternative ways for chip 500, as would be known to persons skilled in the relevant art(s), such as through the use of DC-DC converters, etc.

As shown in the embodiment of FIG. 7, an electrical connection of circuit board 702 is not present that is coupled to pad 504. Thus, mobile TV data signal 110 is not routed from chip 500, through circuit board 702, external to device 702. Instead, mobile TV data is provided external to device 700 via USB data signal 112 through USB connector 706.

FIG. 8 shows chip 500 implemented in another type of device. FIG. 8 shows a device 800 that includes chip 500, according to another example embodiment of the present invention. In an embodiment, device 800 is a mobile device, such as a cell phone, music player, or mobile computer (e.g., mobile handheld computer, laptop, etc.).

As shown in FIG. 8, device 800 includes a circuit board 802, antenna 106, chip 500, a voltage regulator 804, a card connector 806, and a housing 820. As shown in the example of FIG. 8, antenna 106, chip 500, and voltage regulator 804 are mounted to circuit board 802. Housing 820 houses circuit board 802, antenna 106, chip 500, and voltage regulator 804. Housing 820 may have the form of a cell phone housing, music player housing, a mobile computer housing, or other housing, depending on the particular device type of device 800. Housing 820 may be made from plastic, metal, or other material. Card connector 806 extends from circuit board 802, to allow circuit board 802 to be plugged into a mating connector in device 800. Alternatively, card connector 806 is not plugged into a mating connector in device. Instead, circuit board 802 is attached to housing 820, and electrical connections, such as wires, in housing 820 are connected to pins/pads of card connector 806.

Circuit board 802 may be any type of circuit board, including a MiniCard, Mini PCI card, ExpressCard, or mother board. Circuit board 802 may be a card that solely provides mobile TV functionality to device 800. For example, circuit board 802 may be inserted in device 800 to enable mobile TV functionality in device 800. Alternatively, additional functionality may be provided on circuit board 802, and/or further components of device 800 may be mounted to circuit board 802. Circuit board 802 may be configured to be inserted into an externally accessible card slot or socket of device 800, such as a PCMCIA card slot, a MiniCard slot, Mini PCI card slot, ExpressCard slot, etc. Alternatively, circuit board 802 may be a mother board or other type card attached internally to device 800 that is not removable without opening device 800.

In embodiments, chip 500 may be mounted to circuit board 802 in any suitable way, including in an integrated circuit package, such as a dual in-line (DIP) package, leadless chip carrier (LCC), pin grid array (PGA) package, quad flat package (QFP), or ball grid array (BGA) package, including a fine pitch BGA package or wafer-level BGA package.

Card connector 806 may be any type of card connector, including a card connector compatible with the circuit board types mentioned above or other types known to persons skilled in the relevant art(s). Card connector 806 provides a power supply voltage signal 812 and a ground signal 814 to circuit board 802. Thus, power and ground can be received at card connector 806 from a power source external to circuit board 802. Furthermore, pad 504 of chip 500 is coupled to a pin/pad of card connector 806 by an electrical connection 812, to provide mobile TV data signal 110 to card connector 806 to be received in device 800 external to circuit board 802. In an embodiment, mobile TV data signal 110 can be provided to a pair of pins of card connector 806 in a differential configuration.

Power supply voltage signal 812 and ground signal 814 are received from card connector 806 at voltage regulator 804. In a similar fashion as described above for voltage regulator 704 shown in FIG. 7, voltage regulator 804 includes one or more voltage regulators to convert a power supply voltage received on power supply voltage signal 812 to one or more additional power supply voltages for use by chip 500 and/or other components mounted to circuit board 802. For example, as shown in FIG. 8, voltage regulator 804 generates first power supply 514 and second power supply 516 of chip 500. A first electrical connection 808 routed on circuit board 802 is coupled to pad 510 of chip 500 to supply the voltage of first power supply 514. A second electrical connection 810 routed on circuit board 802 is coupled to pad 512 of chip 500 to supply the voltage of second power supply 516. Note that in an alternative embodiment, voltage regulator 804 may be in chip 500, and power supply voltage signal 812 and ground signal 814 may be routed to chip 500 to be supplied to voltage regulator 804. In still another embodiment, a combination of one or more voltage regulators 804 on circuit board 802 and in chip 500 may be used to generate desired power supply voltages from power supply voltage signal 812 and ground signal 814.

As shown in the embodiment of FIG. 8, an electrical connection of circuit board 802 is not present that is coupled to pad 506 and 508. Thus, USB data signal 112, with mobile TV data, is not supplied to device 800 from circuit board 802. Instead, mobile TV data is provided to device 800 via mobile TV data signal 110 through card connector 806. Thus, in the embodiment, of FIG. 8, USB interface 104 of chip 500 is powered (by power signals 514 and 516), yet is unused.

FIG. 9 shows a chip 900, according to another example embodiment of the present invention. Chip 900 is generally similar to chip 500, with some differences described as follows. Chip 900 may be implemented in devices, such as devices 700 and 800, to provide mobile TV functionality. As shown in FIG. 9, chip 900 includes an isolator 906. Furthermore, as shown in FIG. 9, chip 900 is segmented into a pair of electrically isolated power domains: a first power domain 902 and a second power domain 904. In chip 900, mobile TV receiver module 102 receives first and second power signals 514 and 516 in a similar fashion as in chip 500. However, USB interface 104 does not receive first and second power signals 514 and 516. Instead, USB interface 104 receives first and second power signals 908 and 910. First and second power signals 514 and 516 are electrically isolated from first and second power signals 908 and 910 in chip 900. In this manner, USB interface 104 is powered separately from mobile TV receiver module 104. Mobile TV receiver module 102 resides in first power domain 902, and USB interface 104 resides in second power domain 904, and first and second power domains 902 and 904 are maintained in electrical isolation.

First power signal 908 is coupled to a pad 912 of chip 900, and second power signal 910 is coupled to a pad 914 of chip 900. For example, in an embodiment, first power signals 514 and 908 provide power to digital circuits in chip 900 and second power signals 516 and 910 provide power to analog circuits in chip 900. A circuit board (e.g., circuit board 702 or 802) to which chip 900 is mounted can couple the respective digital and analog power voltages separately to mobile TV receiver module 102 and USB interface 104. For example, on the circuit board, a digital power voltage can be coupled to pins 514 and 908, and an analog power voltage can be coupled to pins 516 and 910. In this manner, the analog and digital power voltages are provided, but are maintained isolated on chip 900.

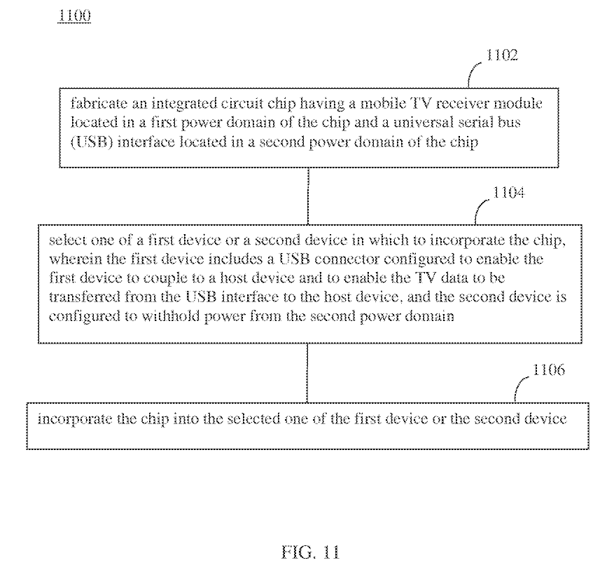

FIG. 10 shows a flowchart 1000 providing example steps for powering a mobile TV chip, such as chip 900, to electrically isolate USB and mobile TV functionality, according to an example embodiment of the present invention. Other structural and operational embodiments will be apparent to persons skilled in the relevant art(s) based on the discussion regarding flowchart 1000. Flowchart 1000 is described as follows.

Flowchart 1000 begins with step 1002. In step 1002, a mobile TV receiver module that performs said down-converting and demodulating is powered with a first power signal. For example as shown in FIG. 9, mobile TV receiver module 102 is powered by first power signal 514 (and second power signal 516). In embodiments, mobile TV receiver module 102 may be powered by any number of one or more power signals, depending on the particular implementation of mobile TV receiver module 102. For example, in an embodiment, mobile TV receiver module 102 receives a 1.2 Volt power signal used to power digital circuitry.

In step 1004, a USB interface that performs said serializing and said transmitting is powered with a second power signal. For example as shown in FIG. 9, USB interface 104 is powered by first power signal 908 (and second power signal 910). In embodiments, USB interface 104 may be powered by any number of one or more power signals, depending on the particular implementation of USB interface 104. For example, in an embodiment, USB interface 104 receives a 1.2 Volt power signal used to power digital circuitry, a 2.5 Volt power signal used to power analog circuitry, and a 3.3 Volt power signal used to power input-output (I/O) circuitry.

In step 1006, electrical isolation between the first power signal and the second power signal is maintained. Electrical isolation is maintained between the power signals of mobile TV receiver module 102 and USB interface 104. In the embodiment of FIG. 9, first and second power signals 514 and 516 are electrically isolated from first and second power signals 908 and 910 in chip 900. In the example embodiment where mobile TV receiver module 102 and USB interface 104 each require a 1.2 V power signal for digital circuitry, mobile TV receiver module 102 and USB interface 104 receive respective 1.2 V power signals that are isolated from each other in respective power domains 902 and 904, and are received at separate pads/pins of chip 900.

In an alternative embodiment, USB interface 104 may be left unpowered. For example, in FIG. 9, power may be withheld from first and second power signals 908 and 910, by not coupling pads 912 and 914 of chip 900 to power signals on a circuit board to which chip 900 is mounted. In this manner, USB interface 104 does not receive power, and thus does not operate. USB interface 104 may be left unpowered in implementations where USB data signal 112 is not used. For instance, chip 900 may be used to provide mobile TV functionality to a device in a similar fashion to chip 500 in device 800, where pads 506 and 508 for USB output data signals 112a and 112b are left uncoupled, and instead mobile TV data signal 110 is used.

Devices where USB interface 104 is not needed include devices where chip 900 is incorporated directly into the device, and the devices are configured to couple more directly to the mobile TV functionality of chip 900, without going through a USB connection. In such devices, power can be withheld from USB interface 104, by not coupling power to power pins (e.g., pads 912 and 914) of chip 900, leaving second power domain 904 unpowered.

When chip 900 is incorporated in a device where USB interface 104 is not powered, chip 900 still includes the unused die “real estate” of USB interface 104. Such unused die real estate may be considered wasted die space. However, because chip 900 is flexibly able to be used in USB enabled devices and non-USB devices, only a single chip fabrication mask set is required for both applications. A chip mask set specific to non-USB devices is not needed, and therefore costs for such a mask set are saved. For example, the costs required for an engineering design team to develop separate mask sets for chips with USB functionality and chips without USB functionality are saved. Furthermore, using chip 900 in non-USB devices does not result in an unnecessary increase in power consumption, because power is withheld from second power domain 904. Thus, having a separate power domain for USB functionality in chip 900 can provide cost savings without increasing power consumption.

Thus, in an embodiment, chip 900 may be used in a first device, which may be a device that uses the USB functionality of chip 900, or a second device, which does not require and does not power the USB functionality of chip 900. FIG. 11 shows a flowchart 1100 providing example steps for assembling a device incorporating a chip, such as chip 900, according to an example embodiment of the present invention. Other structural and operational embodiments will be apparent to persons skilled in the relevant art(s) based on the discussion regarding flowchart 1100. Flowchart 1100 is described as follows.

Flowchart 1100 begins with step 1102. In step 1102, an integrated circuit chip is fabricated having a mobile TV receiver module located in a first power domain of the chip and a universal serial bus (USB) interface located in a second power domain of the chip. For example, the integrated circuit chip may be chip 900, which may be fabricated as a portion of a semiconductor wafer that is subsequently separated from the wafer. As shown in FIG. 9, chip 900 is fabricated such that mobile TV receiver module 102 resides in first power domain 902 and USB interface 104 resides in second power domain 904. Furthermore, first power domain 902 is electrically isolated from second power domain 904.

In step 1104, one of a first device or a second device is selected in which to incorporate the chip. The first device that may be selected includes a USB connector, such as USB connector 706 shown in FIG. 7, which is configured to enable the first device to couple to a host device (e.g., a computer or other device with a display). The first device may optionally include a length of USB cable between the first device and the USB connector. The USB connector enables the TV data to be transferred from USB interface 104 to the host device. For example, the first device may be a dongle or a stick device. In contrast, the second device that may be selected is configured to withhold power from the second power domain (e.g., second power domain 904), such that USB interface 104, which is not needed in the second device, is not powered. For example, the second device may be a cell phone, music player, handheld computer, or other device in which chip 900 is directly incorporated (e.g., mounted to a circuit board that resides in the second device during operation of the second device).

In step 1106, the chip is incorporated into the selected one of the first device or the second device. For example, the chip may be mounted to a circuit board of the selected one of the first device or second device, or otherwise incorporated in the selected device in any manner, as would be known to persons skilled in the relevant art(s).

In this manner, according to flowchart 1100, different device types may be assembled incorporating a chip that provides both mobile TV and USB functionality, such as chip 900, even though the USB functionality is not necessarily used or even powered in a particular assembled device.

In an embodiment, isolators are present in chip 900 to maintain electrical isolation for signals passed between first and second power domains 902 and 904. For example, as shown in FIG. 9, mobile TV data signal 110 output by mobile TV receiver module 102 is received by isolator 906. Isolator 906 generates an isolated version 916 of mobile TV data signal 110, which is received by USB interface 104 (instead of directly receiving mobile TV data signal 110). Isolator 906 includes one or more isolation gates, such as Boolean gates, that provide isolation for signals passing between power domains 902 and 904. For example, a Boolean gate may receive a signal passing from first power domain 902 to second power domain 904. The Boolean gate is configured to be enabled if second power domain 904 is powered, and is forced to a particular state if second power domain 904 is not powered. Appropriate isolation gates for isolator 906, and ways of configuring the same, would be known to persons skilled in the relevant art(s).

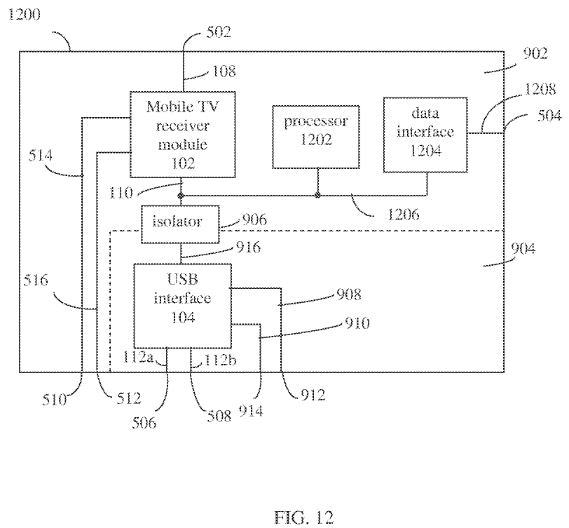

In embodiments, chips 500 and 900 may include additional functionality not shown in FIGS. 5 and 9. Such additional functionality that may be present will depend on the particular applications of chips 500 and 900, and thus can have any number of configurations. For example, FIG. 12 shows a chip 1200 generally similar to chip 900, with some additional components, according to an embodiment of the present invention. As shown in FIG. 12, chip 1200 includes mobile TV receiver module 102, USB interface 104, isolator 906, a processor 1202, a data interface 1204, and a communication bus 1206. This configuration of chip 1200 shown in FIG. 12 is provided merely to illustrate an example USB-enabled mobile TV chip, with some additional functionality, and is not intended to be limiting.

In the embodiment of FIG. 12, processor 1202 may be configured to perform various general processing functions for chip 1200. Furthermore or alternatively, processor 1202 may be used to perform data processing for mobile TV receiver module 102, such as encoding/decoding mobile TV data, etc.

In an embodiment, processor 1202 is configured to service interrupts and/or to respond to commands received from a host device coupled to chip 1200. For example, a host device (e.g., cell phone, computer, music player, etc.) may be coupled to chip 1200 through USB interface 104 (e.g., as described above) and/or through data interface 1204. The interrupts and/or commands may be received by processor 1202 through USB interface 104, data interface 1204, or other interface for chip 1200. Processor 1202 may also be configured to perform command and control monitoring of the overall system of chip 1200. For example, processor 1202 may provide instructions to mobile TV receiver module 102 and/or USB interface 104, and may be configured to monitor operation of mobile TV receiver module 102 and/or USB interface 104.

Processor 1202 may be configured as a central processing unit (CPU) or microcontroller that executes code, as a plurality of logic gates, or in another configuration, as desired for a particular application.

Communication bus 1206 enables communication between various components of chip 1200, including mobile TV receiver 102, USB interface 104, processor 1202, and data interface 1204, which are each coupled to communication bus 1206. Communication bus 1206 may have any bit width, and may be configured in any suitable manner, as desired for a particular application. In the embodiment of FIG. 12, USB interface 104 is coupled to communication bus 1206 through isolator 906.

Data interface 1204 provides an interface for communication bus 1206 external to chip 1200. Data interface 1204 enables mobile TV receiver 102, processor 1202, and/or other component of chip 1200 to communicate with a host device external to chip 1200, including providing mobile TV data (e.g., mobile TV data of mobile TV data signal 110) external to chip 1200. In the example of FIG. 12, data interface 1204 is coupled to pad 504, but in further embodiments may be coupled to a plurality of pads of chip 1200 (e.g., in a parallel data interface configuration). Data interface 1204 may provide data and receive data external to chip 1200 in a parallel or serial fashion.

Data interface 1204 may be a special purpose or standard interface type. For example, data interface 1204 may be an SDIO (Secure Digital Input Output), SPI (SCSI parallel interface), a host interface, or other interface type mentioned elsewhere herein or otherwise known.

Chip 1200 may include additional components/peripherals not shown in FIG. 12, as desired for a particular application.

### EXAMPLE SOFTWARE EMBODIMENTS

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system and to storing software in a computer system or other device. The invention, in an embodiment, is directed to such computer program products.

In an embodiment where aspects of the present invention are implemented using software/firmware, the software/firmware may be stored in a computer program product and loaded into a computer system or other device using a removable storage drive, hard drive, or communications interface. The computer system or other device may execute the software/firmware from storage such as a hard drive or memory device (e.g., a ROM device such as an electrically erasable ROM, electrically programmable ROM, a RAM device such as a static RAM, dynamic RAM, etc.). This control logic software/firmware, when executed by a processor, causes the processor to perform the functions of the invention as described herein.

According to an example embodiment, a mobile device may execute computer-readable instructions to enable USB and mobile TV content, as further described elsewhere herein, and as recited in the claims appended hereto.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A mobile television (TV) system integrated circuit (IC) chip, comprising:
a mobile TV receiver module that receives a radio frequency (RF) mobile TV signal that includes TV data, wherein the mobile TV receiver module is configured to generate a mobile TV data signal that includes the TV data; and
a universal serial bus (USB) interface that receives the mobile TV data signal, wherein the USB interface is configured to generate a USB output data signal that includes the TV data.

2. The chip of claim 1, wherein the USB interface is configured to operate according to a USB standard revision 2.0 high speed mode.

3. The chip of claim 1, wherein the RF mobile TV signal is one of a digital video broadcasting-handheld (DVB-H) signal, a digital video broadcasting-satellite handheld (DVB-SH) signal, a digital multimedia broadcasting (DMB) signal, a TDtv signal, a 1seg signal, a DAB signal, or a MediaFLO signal.

4. The chip of claim 1, wherein the mobile TV receiver module comprises:
a tuner that down-converts the RF mobile TV signal; and
a demodulator that demodulates the down-converted RF mobile TV signal to generate the mobile TV data signal.

5. The chip of claim 1, further comprising:
a power pad configured to interface with a power signal external to the chip;
wherein the USB interface and mobile TV receiver module are coupled to the power pad to be enabled to receive power from the power signal.

6. The chip of claim 1, further comprising:
a first I/O pad coupled to the RF mobile TV signal;
a second I/O pad coupled to the mobile TV data signal;
a third IPO pad coupled to a “+” differential signal portion of the USB output data signal; and
a fourth IPO pad coupled to a “−” differential signal portion of the USB output data signal.

7. The chip of claim 1, further comprising:
a first power pad configured to interface with a first power signal external to the chip; and
a second power pad configured to interface with a second power signal external to the chip;
wherein the mobile TV receiver module is coupled to the first power pad to be enabled to receive power from the first power signal;
wherein the USB interface is coupled to the second power pad to be enabled to receive power from the second power signal; and
wherein the first power pad is electrically isolated from the second power pad in the chip.

8. The chip of claim 6, further comprising:
an isolator configured to receive the mobile TV data signal from the mobile TV receiver module, and to generate an isolated version of the mobile TV data signal;
wherein the USB interface receives the isolated version of the mobile TV data signal.

9. An electrical device, comprising:
an antenna configured to receive a radio frequency (RF) mobile TV signal that includes TV data;
a mobile TV receiver module that receives the radio frequency (RF) mobile TV signal from the antenna, wherein the mobile TV receiver module is configured to generate a mobile TV data signal that includes the TV data; and
a universal serial bus (USB) interface that receives the mobile TV data signal, wherein the USB interface is configured to generate a USB output data signal that includes the TV data.

10. The device of claim 9, wherein the USB interface is configured according to a USB standard revision 2.0 high speed mode.

11. The device of claim 9, further comprising:
an integrated circuit (IC) chip that includes the mobile TV receiver module and the USB interface; and
a circuit board that mounts the chip and the antenna.

12. The device of claim 11, further comprising:
a USB connection mechanism.

13. The device of claim 12, wherein the USB connection mechanism is a USB connector.

14. The device of claim 12, further comprising:
at least one voltage regulator configured to receive a USB power signal from the USB connection mechanism, and to convert the USB power signal to at least one additional power signal.

15. The device of claim 12, wherein the chip includes a power pad coupled to a power signal of the circuit board;
wherein the USB interface and mobile TV receiver module are coupled to the power pad to be enabled to receive power from the power signal.

16. The device of claim 12, wherein the chip further includes:
a first I/O pad that is coupled to the antenna and receives the RF mobile TV signal;
a second I/O pad that receives the mobile TV data signal from the mobile TV receiver module;
a third I/O pad coupled to a “+” differential signal portion of the USB output data signal; and
a fourth I/O pad coupled to a “−” differential signal portion of the USB output data signal;
wherein the third I/O pad and the fourth I/O pad are coupled to respective pins of the USB connection mechanism through respective electrical connections of the circuit board.

17. The device of claim 12, wherein the chip further comprises:
a first power pad and a second power pad;
wherein the first power pad is coupled to a first power signal of the circuit board; and
wherein the second power pad is coupled to a second power signal of the circuit board;
wherein the mobile TV receiver module is coupled to the first power pad to be enabled to receive power from the first power signal;
wherein the USB interface is coupled to the second power pad to be enabled to receive power from the second power signal; and
wherein the first power pad is electrically isolated from the second power pad in the chip.

18. The device of claim 17, wherein the chip further comprises:
an isolator configured to receive the mobile TV data signal from the mobile TV receiver module, and to generate an isolated version of the mobile TV data signal;
wherein the USB interface receives the isolated version of the mobile TV data signal.

19. The device of claim 12, wherein the chip further comprises:
a first power pad and a second power pad;
wherein the first power pad is coupled to a first power signal of the circuit board; and
wherein the second power pad is not coupled to a signal of the circuit board;
wherein the mobile TV receiver module is coupled to the first power pad to be enabled to receive power from the first power signal;
wherein the first power pad is electrically isolated from the second power pad in the chip; and
wherein the USB interface is coupled to the second power pad and is thereby not powered.

20. The device of claim 12, wherein the device is a dongle or a stick.

21. The device of claim 11, wherein the device is a cell phone, music player, or mobile handheld computer.

22. A method in an integrated circuit chip for receiving mobile television (TV), comprising:
receiving a radio frequency (RF) mobile TV signal that includes TV data;
down-converting and demodulating the received RF mobile TV signal to generate a mobile TV data signal that includes the TV data;
formatting the mobile TV data signal into a USB serial data stream; and
transmitting the USB data stream from the chip in a USB data output signal.

23. The method of claim 22, further comprising:
powering a mobile TV receiver module that performs said down-converting and demodulating with a power signal; and
powering a USB interface that performs said serializing and said transmitting with the power signal.

24. The method of claim 22, further comprising:
powering a mobile TV receiver module that performs said down-converting and demodulating with a first power signal;
powering a USB interface that performs said formatting and said transmitting with a second power signal; and
maintaining electrical isolation between the first power signal and the second power signal.

25. A method for assembling a device, comprising:
fabricating an integrated circuit chip having a mobile TV receiver module located in a first power domain of the chip and a universal serial bus (USB) interface located in a second power domain of the chip, wherein the first power domain is electrically isolated from the second power domain, wherein the USB interface is coupled to the mobile TV receiver module to receive TV data from the mobile TV receiver module; and
selecting one of a first device or a second device in which to incorporate the chip;
wherein the first device includes a USB connection mechanism configured to enable the first device to couple to a host device and to enable the TV data to be transferred from the USB interface to the host device, and
wherein the second device is configured to withhold power from the second power domain.

26. The method of claim 25, further comprising:
incorporating the chip into the selected one of the first device or the second device.

27. The method of claim 26, wherein the first device is selected, wherein said incorporating comprises:
mounting the chip to a circuit board of the first device;
coupling the USB interface to the USB connection mechanism;
coupling a power signal of the circuit board to the first power domain; and
coupling a power signal of the circuit board to the second power domain.

28. The method of claim 27, wherein the first device is a dongle or a stick, wherein said incorporating comprises:
incorporating the chip into the dongle or the stick.

29. The method of claim 26, wherein the second device is selected, wherein said incorporating comprises:
mounting the chip to a circuit board of the second device;
coupling an output of the mobile TV receiver module to an electrical connection of the circuit board; and
coupling a power signal of the circuit board to the first power domain;
wherein power is withheld from the second power domain.

30. The method of claim 26, wherein the first device is a cell phone, a music player, or a mobile computer, wherein said incorporating comprises:
incorporating the chip into the cell phone, the music player, or the mobile computer.
